(19) United States
(12) Patent Application Publication
(10) Pub. No.: US 2012/0000794 A1
(43) Pub. Date: Jan. 5, 2012

(54) ONLINE WATER ANALYSIS

(75) Inventors: Huijun Zhao, Highland Park (AU); Shanqing Zhang, Mudgeeraba (AU); Nicholas George Mathiou, Nathan (AU)

(73) Assignee: AQUA DIAGNOSTIC PTY LTD, South Melbourne (AU)

(21) Appl. No.: 12/520,233

(22) PCT Filed: Dec. 21, 2007
(86) PCT No.: PCT/AU07/01988

§ 371 Date: Jun. 23, 2010

(30) Foreign Application Priority Data
Dec. 22, 2006 (AU) AU 2006907133

(51) Int. Cl. G01N 27/26

(52) U.S. Cl. 205/788; 204/407

(57) ABSTRACT

A method of determining chemical oxygen demand (COD) of a water sample, which is useful in an on-line configuration comprising the steps of a) applying a constant potential bias to a photoelectrochemical cell, having a photoactive working electrode, optionally a reference electrode and a counter electrode, and containing a supporting electrolyte solution; b) illuminating the working electrode with a light source and recording the background photocurrent produced at the working electrode from the supporting electrolyte solution; c) adding a water sample, to be analysed, to the photoelectrochemical cell; d) illuminating the working electrode with a light source and recording the hydro dynamic photocurrent produced under continuous flow of the water to be analysed; e) determining the chemical oxygen demand of the water sample using a number of different formulae. The applied potential is preferably from −0.4 to +O.8V more preferably about +0.3V. The method is applicable to water samples in the pH range of 2 to 10. An injection volume of 13 μL is preferred. A preferred flow rate is 0.3 mL/min.

### FIELD OF THE INVENTION

This invention relates to a new method for determining oxygen demand of water using photoelectrochemical cells. In particular, the invention relates to an improved direct photoelectrochemical method of determining chemical oxygen demand of water samples using a titanium dioxide nanoparticulate semiconductive electrode. It is particularly adapted for use in an online continuous measurement environment.

### BACKGROUND TO THE INVENTION

Nearly all domestic and industrial wastewater effluents contain organic compounds, which can cause detrimental oxygen depletion (or demand) in waterways into which the effluents are released. This demand is due largely to the oxidative biodegradation of organic compounds by naturally occurring microorganisms. These microorganisms utilize the organic material as a food source. In this process, organic carbon is oxidised to carbon dioxide, while oxygen is consumed and reduced to water.

An oxygen demand assay based on photoelectrochemical degradation principles has been previously disclosed in patent specification WO2004088305 where the measurement was based on both exhaustive and non exhaustive degradation principles.

It is an object of the present invention to develop an analyzer based on non-exhaustive degradation principles. It is another object of this invention to develop a online COD analyzer.

### BRIEF DESCRIPTION OF THE INVENTION

To this end the present invention provides a method of determining chemical oxygen demand (COD) of a water sample, comprising the steps of
a) applying a constant potential bias to a photoelectrochemical cell, having a photoactive working electrode and a counter electrode, and containing a supporting electrolyte solution;
b) illuminating the working electrode with a light source and recording the background photocurrent produced at the working electrode from the supporting electrolyte solution;
c) adding a water sample, to be analyzed, to the photoelectrochemical cell;
d) illuminating the working electrode with a light source and recording the hydro dynamic photocurrent produced under continuous flow of the water to be analyzed;
e) determining the chemical oxygen demand of the water sample using the formula

$$[ COD ] = \frac{γ δ}{FAD} \times 8000 {i}_{peak} ( mg \text{/} L of {O}_{2} )$$

$$or \\ [ COD ] = \frac{δ}{FAD} \times 8000 {i}_{sp} ( mg \text{/} L of {O}_{2} )$$

where γ is the dispersion coefficient, δ is the concentration diffusion layer thickness, D is the diffusion coefficient, A is the electrode area, F is the Faraday constant, iₚₑₐₖ is the photocurrent peak height and iₛₚ is the saturated photocurrent.

The applied potential is preferably from −0.4 to +O.8V more preferably about +0.3V.

The method is applicable to water samples in the pH range of 2 to 10.

Increasing the injection volume increases sensitivity but the linear response is narrower at higher volumes. An injection volume of 13 μL is preferred.

A slow flow rate is preferred in order to achieve indiscriminate oxidation of organic compounds. However too low a flow rate may lead to lower sensitivity. A preferred flow rate is 0.3 mL/min.

In another aspect the present invention provides a second method of measuring COD for online monitoring comprising the steps of
a) applying a constant potential bias to a photoelectrochemical cell, having a photoactive working electrode and a counter electrode, and containing a supporting electrolyte solution;
b) illuminating the working electrode with a light source and recording the background photocurrent produced at the working electrode from the supporting electrolyte solution;
c) adding a water sample, to be analysed, into the photoelectrochemical cell;
d) illuminating the working electrode with a light source and recording the hydro dynamic photocurrent produced under continuous flow of the water to be analysed;
e) determining the Chemical Oxygen Demand of the water sample using the formula

$$COD ( mg \text{/} L of {O}_{2} ) = \frac{{Q}_{net}}{4 α FV} \times 32000 = k {Q}_{net}$$

$$Where$$

$${Q}_{net} = α FV {\sum }_{i = 1}^{m} {n}_{i} {C}_{i}$$

$$α = \frac{{Q}_{net}}{{Q}_{theoretical}}$$

Qₙₑₜ is the amount of electrons captured during the continuous flow detection,
Q_{theoretical} refers to the theoretical charge required for mineralization of the injected sample
n_{i,} is the oxidation number namely the number of electrons transferred for an individual organic compound during the photoelectrocatalytic degradation,
Cᵢ is the molar concentration of individual organic compound,
F is the Faraday constant,
V is the sample volume,
K is the slope, which can be obtained by calibration curve method or standard addition calibration method.

These methods are useful in online analysis.

In addition to the counter electrode it is preferred to also use a reference electrode.

In another aspect this invention provides an online analyser for analyzing water quality on a continuous basis which includes
a) an electrochemical cell containing a photoactive working electrode and a counter electrode,
b) a supporting electrolyte solution chamber;
c) a light source to illuminate the working electrode
d) continuous flow injection means to provide a sample solution to the cell
e) control means to
   i) actuate the light source and record the background photocurrent produced at the working electrode from the supporting electrolyte solution;
   ii) control the flow rate of the water sample, to be analysed, to the photoelectrochemical cell;
   iii) actuate the light source and record the hydro dynamic photocurrent produced under continuous flow of the water to be analysed;
   iv) determine the chemical oxygen demand of the water sample using any of the formula given above.

### DESCRIPTION OF THE DRAWINGS

Two embodiments of the invention are Illustrated in the drawings.

FIG. 1 is a schematic illustration of the detection cell used;

FIG. 2 shows a set of typical photocurrent-time profiles obtained in the presence of organic compounds under continuous flow conditions;

FIG. 3 illustrates the effect of potential on the peak response of 100 μM glucose;

FIG. 4 illustrates the effect of injection volume on the photoelectrochemical detection;

FIG. 5 illustrates the effect of flow rate on the photoelectrochemical detection;

FIG. 6 illustrates the effect of pH on the photoelectrochemical detection of 100 μM glucose;

FIG. 7 illustrates the effect of (a) The quantitative relationship between the peak height and concentration (μM) of organic compounds. (b) The quantitative relationship between the peak height and theoretical COD. (c) The correlation between the PECOD and theoretical COD for the synthetic COD test samples using glucose as COD standard;

FIG. 8 illustrates the photoelectrochemical detection of COD value using glucose as a standard;

FIG. 9 illustrates the Pearson correlation between the photoelectrochemical COD and standard dichromate COD for real sample measurements;

FIG. 10 illustrates a typical photocurrent response in continuous flow analysis;

FIG. 11 illustrates the effect of flow rate on (a) the photoelectrochemical charge and (b) the oxidation percentage;

FIG. 12 illustrates the effect of pH on the photoelectrochemical detection of 100 μM glucose;

FIG. 13 illustrates the photoelectrochemical determination of COD value of the synthetic samples: (a) Qₙₑₜ versus C (μM) relationship and (b) the correlation between the PeCOD and theoretical COD;

FIG. 14 shows the continuous flow-based photoelectrochemical determination of COD of a real sample using the standard addition method.

### DETAILED DESCRIPTION OF THE INVENTION

### Method 1

### Materials and Sample Preparation:

The Indium Tin Oxide (ITO) conducting glass slides (8 Ω/square) were supplied by Delta Technologies Limited. Titanium butoxide (97%, Aldrich), sucrose, glucose, glutamic acid, and sodium perchlorate were purchased from Aldrich without further treatment prior to use. All other chemicals were of analytical grade and purchased from Aldrich unless otherwise stated. High purity deionised water (Millipore Corp., 18 Ωcm) was used for solution preparation and the dilution of real wastewater samples.

The GGA synthetic samples used for this study were prepared according to the reported method. All real samples used for this study were collected from bakeries, sugar plants and breweries, based in Queensland, Australia. All samples were preserved according to the guidelines of the standard method. When necessary, the samples were diluted to a suitable concentration prior to the analysis. After dilution, the same sample was subject to the analysis by both the standard dichromate COD method and the flow photoelectrochemical COD detector. A certain amount of solid NaClO₄ equivalent to 2M was added to the sample.

Preparation of TiO₂ electrodesis the same as previously described in patent specification WO2004088305.

### Apparatus and Methods:

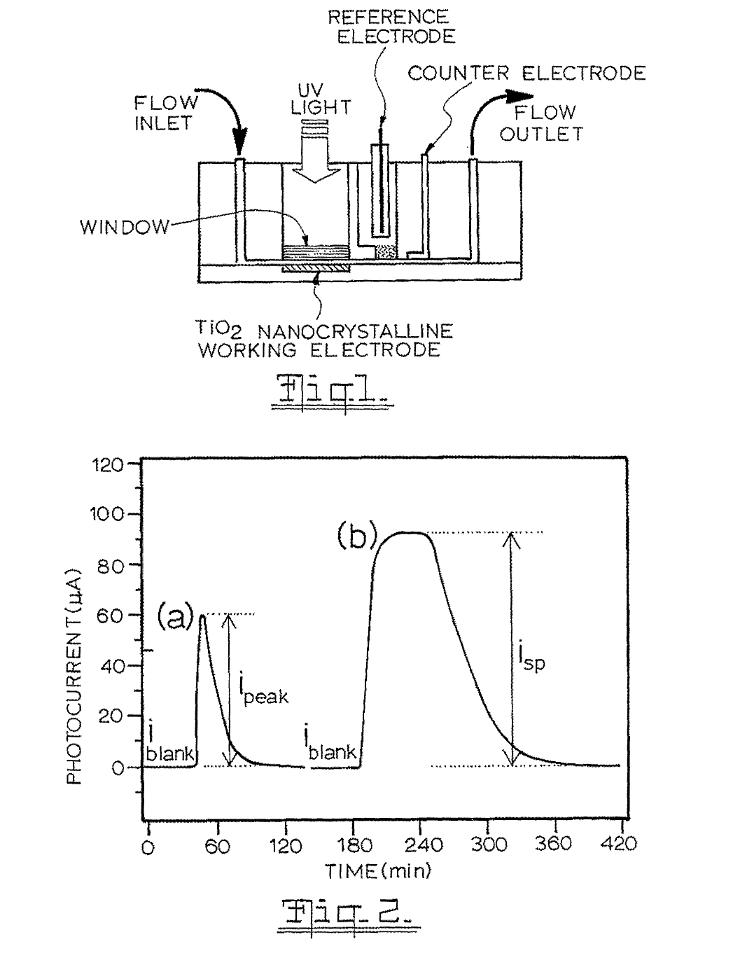

All photoelectrochemical experiments were performed at 23° C. in a thin-layer photoelectrochemical cell with a window for illumination (see FIG. 1). It consists of a three-electrode system with a TiO₂ coated working electrode. The flow path and the photoelectrochemical reaction zone were confined by a shaped spacer. The thickness of the spacer is 0.2 mm and the diameter of the window is 10 mm. A saturated Ag/AgCl electrode and a platinum mesh were used as the reference and counter electrodes, respectively. A voltammograph (CV-27, BAS) was used for application of potential bias. Potential and current signals were recorded using a computer coupled to a Maclab 400 interface (AD Instruments). Illumination was carried out using a 150 W xenon arc lamp light source with focusing lenses (HF-200w-95, Beijing Optical Instruments). To avoid the sample solution being heated by infrared light, a UV-band pass filter (UG 5, Avotronics Pty. Limited) was used. Standard COD value (dichromate method) of all the samples was measured with an EPA approved COD analyzer (NOVA 30, Merck).

### Analytical Signal Measurement

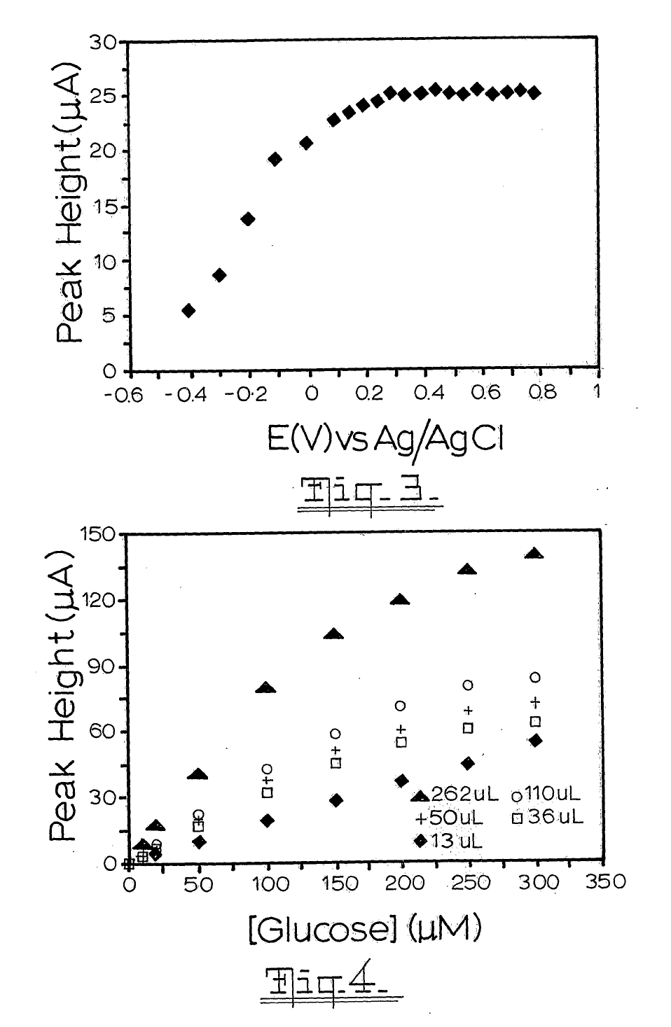

FIG. 2 shows a set of typical photocurrent-time profiles obtained in the presence of organic compounds under continuous flow conditions with a constant applied potential of +0.30 V and light intensity of 6.6 mW/cm². The peak-shaped photocurrent profile is the result of concentration dispersion effect of sample flow. The peak in FIG. 2a shows the unsaturated photocurrent profile with relatively small injection sample volume while the peak in FIG. 2 b shows the saturated photocurrent profile with a large injection sample volume. The baseline (i_{blank}) for both cases resulted from the photoelectrocatalytic oxidation of water and has been electronically offset to zero. Both peak photocurrent (iₚₑₐₖ for unsaturated photocurrent profile) and saturated photocurrent (iₛₚ for saturated photocurrent profile) have resulted from the photoelectrocatalytic oxidation of organic compounds.

As the baseline is the blank (i_{blank}) for both cases and offset to zero, both iₚₑₐₖ and iₛₚ are net photocurrents, originating from the oxidation of organics and so can be quantitatively related to the diffusion limiting current (iₛₛ), obtaining from a stationary cell. All organics transported to the TiO₂ electrode surface can be indiscriminately and fully oxidized. Therefore, both iₚₑₐₖ and iₛₚ can be used to quantify the COD value of a sample.

### Analytical Signal Quantification

The quantitative relationship between the net photocurrent (iₚₑₐₖ or iₛₚ) obtained under the continuous flow, non-exhaustive photocatalytic oxidation conditions can be developed based on the following postulates: (i) all organic compounds at the electrode surface are stoichiometrically oxidized to their highest oxidation state (fully oxidised); (ii) the overall photocatalytic oxidation rate is controlled by the transport of organics to the electrode surface and the bulk solution concentration-time profile follows the flow-injection dispersion profile; (iii) the applied potential bias is sufficient to remove all photoelectrons generated from the photocatalytic oxidation of organics (100% photoelectron collection efficiency). The concentration dispersion in flow-injection can be described by the dispersion coefficient, γ, which is defined as:

$$γ = \frac{{C}^{o}}{{C}_{t}} \\ or \\ {C}_{t} = \frac{1}{γ} {C}^{o} \qquad ( .1 )$$

where, C^{o} and Cₜ are the original concentration and the concentration at a given time, respectively. The dispersion coefficient (γ) is a constant for any given system setup and can be experimentally measured.

The maximum photocurrent (iₚₑₐₖ) is achieved when Cₜ=Cₘₐₓ, which yields:

$$γ = \frac{{C}^{o}}{{C}_{max}} or {C}_{max} = \frac{1}{γ} {C}^{o} ( 0 < y < ∞ ) \qquad ( .2 )$$

The system can attain a saturated status when a large volume sample is injected. Under such conditions, the maximum photocurrent (iₛₚ) is achieved when Cₜ=Cₘₐₓ=C^{o}. That is:

$$γ = \frac{{C}^{o}}{{C}_{max}} = 1 or {C}_{max} = {C}^{o} \qquad ( .3 )$$

Under the steady-state hydrodynamic mass transfer conditions (Postulate (ii) above), the rate of overall reaction can be expressed as:

$$Rate = \frac{D}{δ} {C}_{t} \qquad ( .4 )$$

where, D is the diffusion coefficient and δ is the concentration diffusion layer thickness. However, δ is a constant under a given hydrodynamic condition (i.e. flow rate).

According to the postulates (i) and (iii) above, the number of electrons transferred (n) during photoelectrochemical degradation is constant for a given analyte and the maximum photocurrent (iₚₑₐₖ or iₛₚ) can, therefore, be used to represent the maximum rate of reaction. According to Equation 0.2, the peak photocurrent can be given as:

$${i}_{peak} = \frac{nFAD}{δ} {C}_{max} = \frac{nFAD}{δγ} {C}^{o} \qquad ( 5 )$$

where A and F refer to electrode area and Faraday constant respectively.

According to Equation 2 and 3, the saturated photocurrent can be given as:

$${i}_{sp} = \frac{nFAD}{δ} {C}_{max} = \frac{nFAD}{δ} {C}^{o} \qquad ( 6 )$$

Equations 0.5 and 0.6 define the quantitative relationship between the maximum photocurrent and the concentration of analyte. Convert the molar concentration into the equivalent COD concentration (mg/L of O₂), we have:

$$\begin{matrix}{i}_{peak} = \frac{FAD}{δγ} \times \frac{1}{8000} [ COD ] & ( 7 a ) \\ [ COD ] = \frac{γδ}{FAD} \times 8000 {i}_{peak} ( mg \text{/} L of {O}_{2} ) & ( 7 b ) \\ {i}_{sp} = \frac{FAD}{δ} \times \frac{1}{8000} [ COD ] & ( 8 a ) \\ [ COD ] = \frac{δ}{FAD} \times 8000 {i}_{sp} [ mg \text{/} L of {O}_{2} ) & ( 8 b )\end{matrix}$$

Equations 7b and 8b are valid for determination of COD in a sample that contains a single organic compound. The COD of a sample contains more than one organic species can be represented as:

$$\begin{matrix}[ COD ] \approx \frac{γδ}{FA \overline{D}} \times 8000 {i}_{peak} ( mg \text{/} L of {O}_{2} ) & ( .9 a ) \\ [ COD ] \approx \frac{δ}{FA \overline{D}} \times 8000 {i}_{sp} ( mg \text{/} L of {O}_{2} ) & ( .9 b )\end{matrix}$$

where D̅ is the composite diffusion coefficient that depends on the sample composition that is a constant for a given sample.

### Optimization of Analytical Signal

### Effect of Potential:

The photocatalytic degradation efficiency at TiO₂ depends on the degree of recombination of photoelectrons and holes. The recombination will lead to the disappearance of holes; therefore, the recombination needs to be suppressed. In this invention the photoelectrons are “trapped” by electrochemical means rather than oxygen. The photoelectrons are subsequently forced to pass into the external circuit and to the auxiliary electrode, where the reduction of oxygen (or other species) takes place. FIG. 3 shows the effect of applied potentials where 100 μM glucose was tested. In the region between −0.4V and 0V, the photocurrent resulting from the oxidation of the glucose increased almost linear with the increase of potential. This is because the collection of electron by the conductive ITO layer in this region is a control step among all the reaction processes, including photocatalytic reactions (the generation of holes and electrons), the oxidation of organic compounds by the holes, the electron transfer from valence band to the conduction band and the reduction reaction at the counter electrode. Under the given experimental conditions, an increase of applied potential (i.e. a positive shift) leads to an increase in the electromotive force, which, in turn, leads to a proportional increase of photocurrent. With the further increase of potential (0-+0.25V), the photocurrent kept increase slowly and but not as quickly as before. At a potential above +0.25V, the charge reached its maximum and there was no significant increasing event up to +0.8V. This demonstrates that the photoelectrons are drawn efficiently at the potential of +0.3V or more positive and that the harvesting of photoelectrons is no longer a controlling step in the photoelectrochemical reaction. At this potential the mass transport of organic compounds to TiO₂ is a control step, which leads to a linear relationship between photocurrent and organic compound concentration. Therefore +0.3V was subsequently used as the detection potential for the rest optimization of experimental conditions and determination of COD in synthetic and real samples.

### Effect of Injection Volume and Flow Rate:

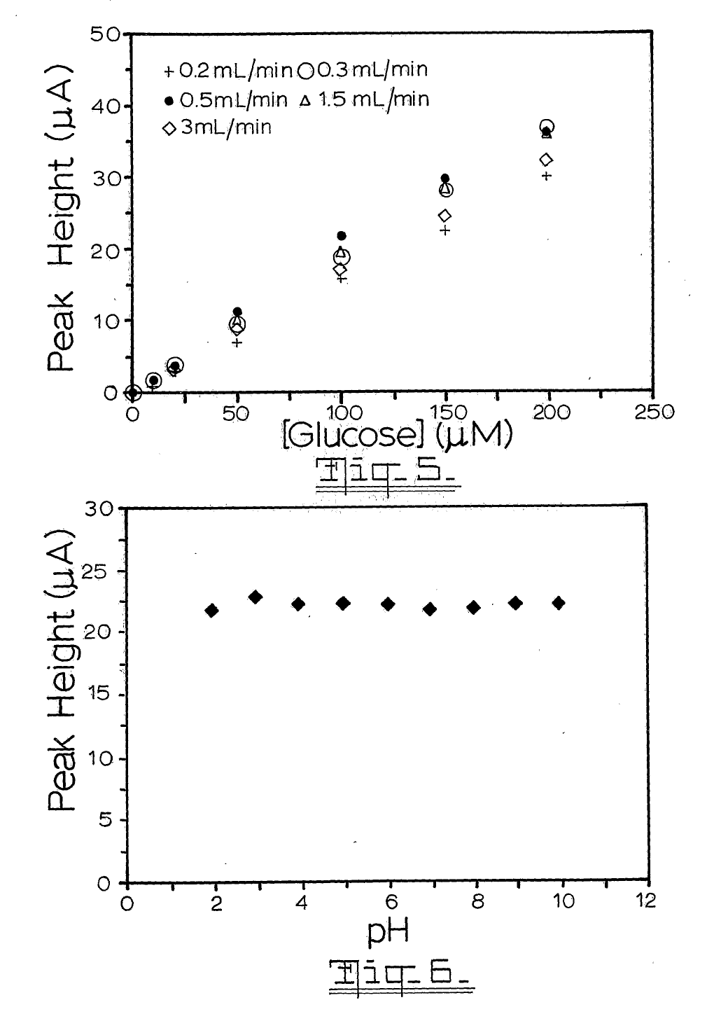

The injection volume and flow rate determine the detection limits, the linear range and sample throughput in flow injection analysis. FIG. 4 shows the effect of injection volume on the photoelectrochemical detection of glucose at a flow rate of 0.3 mL/min. Though FIG. 4 clearly indicates that a larger injection volume results in higher sensitivity, such a larger injection volume also suffers from a narrower linear range. Thus, as an example, when the injection volume was 262 μL, the detection limit could be as low as 0.1 ppm COD, while the linear range was only up to 100 μM glucose (19.2 ppm COD). However, when the injection volume was lower, at 13 μL, the detection limit was about 1 ppm COD and the linear range continued up to 100 ppm COD.

In a real application, a 1 ppm detection limit is likely to be sufficient, while an upper linear range of only 20 ppm COD will normally be impractical. An upper linear range of 100 ppm COD is desirable. Furthermore, a smaller sample volume also has an advantage in terms of higher sample throughout. Note that a 13 μL injection volume has a sample throughout of 60 per hour while a 262 μL injection volume has a throughput as low as 10 per hour. Therefore, in this work, a standard injection volume of 13 μL was established.

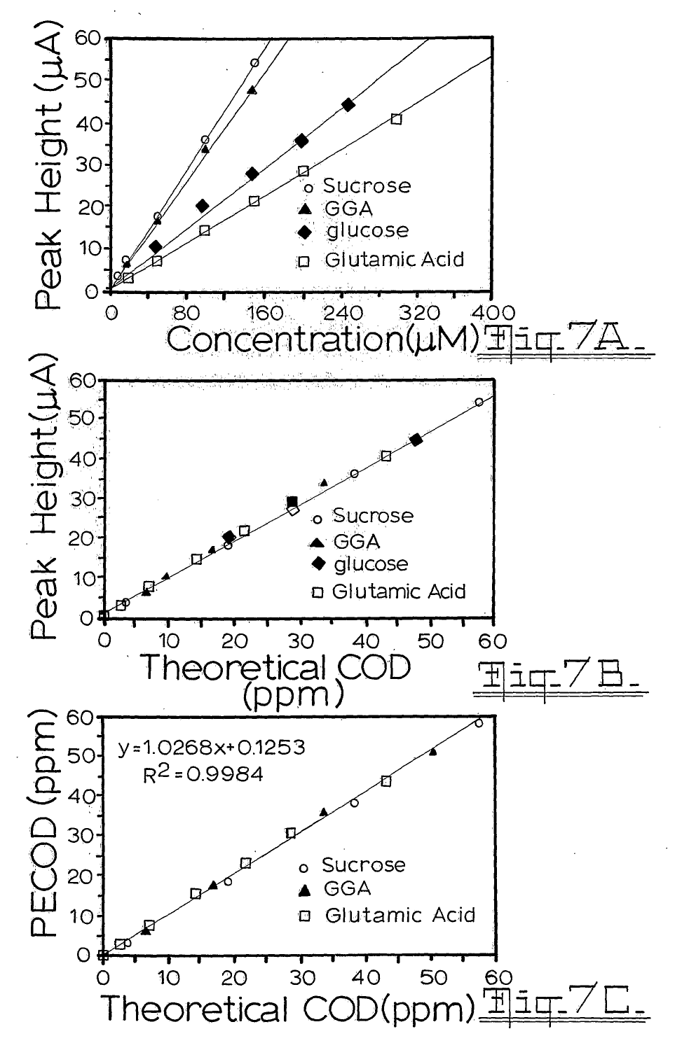

FIG. 5 shows the effect of flow rate of the analytical signal. It was found that a slower flow rate (i.e. 0.3 mL/min) offers a higher sensitivity and wider linear range. The lower flow rate favors a longer contact time, and therefore allows a more complete equilibration and more sensitive response. Also, at a slower flow rate, less oxidation intermediates will be removed before further oxidation. However, while a low flow rate is essential to achieve indiscriminative oxidation of organic compounds, too low a flow rate (e.g., 0.2 mL/min) may lead to lower sensitivity due to dispersion of the analyte in the flow tubing. Thus a flow rate of 0.3 mL/min was set as a standard for further experimentation.

### Effect of pH:

Variation of pH causes change in the band edge potential of the TiO₂ electrode due to the flat band potential and the band edge potential of oxide semiconductors which have a Nernstian dependence on the pH of the solutions. Moreover, speciation of the TiO₂ surface is pH dependent, and so can affect the level of photoelectrochemical oxidation of water and organic matters in the photoelectrochemical system. Levels of pH<2 were not tested, as the pH of real samples are generally at pH>2. Furthermore, there is a possibility that high acidity would damage ITO sublayer of the TiO₂ electrode. pH effects therefore were investigated under experimental conditions that had been previously optimised. The injection of a blank sample (containing only a 2M NaClO₄ solution) with different pH levels (2<pH<10) did not lead to significant variations in peak response, indicating that the change of pH in this range did not affect the photoelectrochemical oxidation of water.

FIG. 6 shows the effect of pH on the detection of 100 μM glucose (i.e. 19.2 ppm COD). The peak heights shown in FIG. 6 were obtained in the range of 2<pH<10 and were almost identical. These results demonstrate that pH variations do not affect the oxidation reaction rate of glucose significantly across a wide pH range.

However, larger peak responses were observed for injection of 2M NaClO₄ at pH=11 and pH=12, indicating that the reaction rate of water splitting may be accelerating dramatically at these very high pH levels. The efficiency of the water splitting reaction is known to be significantly enhanced at high alkaline conditions. Nevertheless, as the pH of wastewater is normally in the range 2<pH<10, where the detection responses are independent of pH, the method is widely applicable.

### Validation of Analytical Principle

Validation of the proposed analytical principle (Equations 5 to 8) was firstly carried out using a group of synthetic samples.

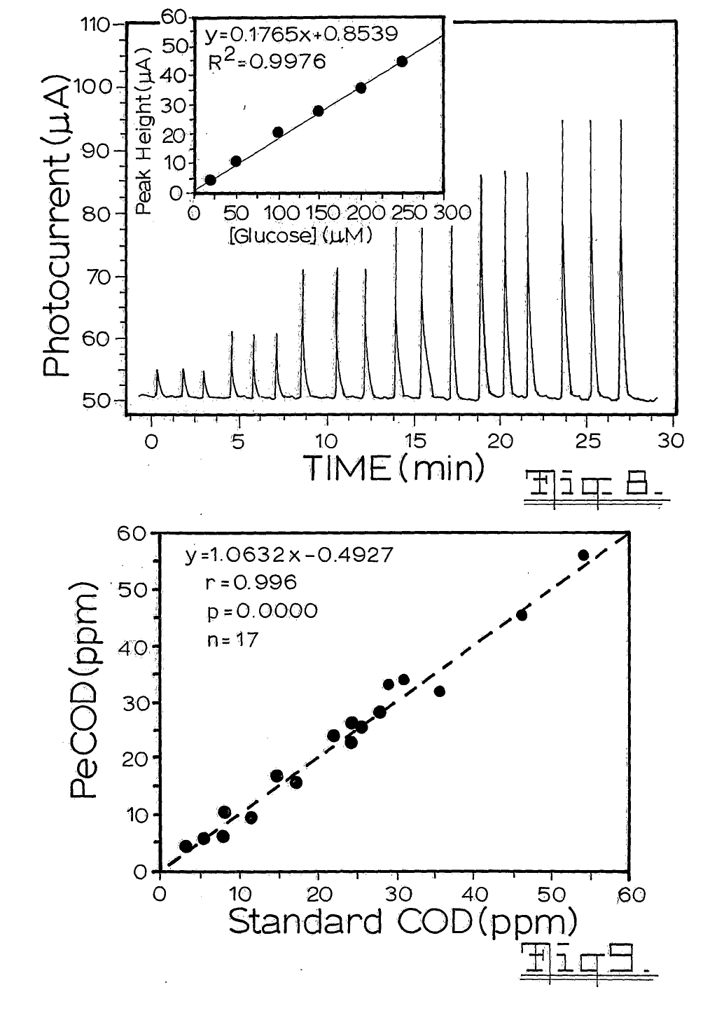

FIG. 7a shows the plots of iₚₑₐₖ against the molar concentrations of organic compounds. Linear relationships between iₚₑₐₖ and C^{o}, as predicted by Equation 5, were obtained for all compounds investigated. Different slopes of iₚₑₐₖ versus C^{o} curves for different organics are observed. The slopes decrease in the order of sucrose, GGA, glucose and glutamic acid, following the same order as the number of electrons required to fully oxidize each of the organics (i.e. sucrose (N=48), GGA (N=42), glucose (N=24) and glutamic acid (N=18)). More importantly, the slope ratio between any given two of the organic compounds investigated equals their electron transferred numbers (N₁/N₂), further validating Equation 5. This observation also confirms that all organic compounds at the electrode surface have been indiscriminately mineralised, demonstrating that postulate (i) is valid under the chosen experimental conditions.

The data of FIG. 7a also validate postulates (ii) and (iii). Equation 6 can be validated in a similar manner as the characteristics of the iₛₚ versus C^{o} curves are the same as those of iₚₑₐₖ versus C^{o} curves shown in FIG. 7a.

FIG. 7b presents plots of iₚₑₐₖ against the theoretical COD value of the samples. A linear relationship with the same slope for all organic compounds is obtained, thus validating Equation 7a.

Equation 8a can be validated in a similar manner as the characteristics of the iₛₚ versus COD curve are the same as those of the iₚₑₐₖ versus COD curve shown in FIG. 7b.

FIG. 7c presents a plot of the measured COD (PeCOD) against the theoretical COD value of the samples. The line of best fit with a slope of 1.0268 and R² of 0.9984 is obtained. This near unity curve slope demonstrates the applicability of Equation 7b for COD determination. In fact, the data also validate Equation 9a as the GGA sample consists of more than one organic compound. Equations 8b and 9b can be validated in a similar manner as the characteristics of PeCOD versus Theoretical COD curve are the same as those of the iₚₑₐₖ versus COD curve shown in FIG. 7c.

### Real Sample Analysis

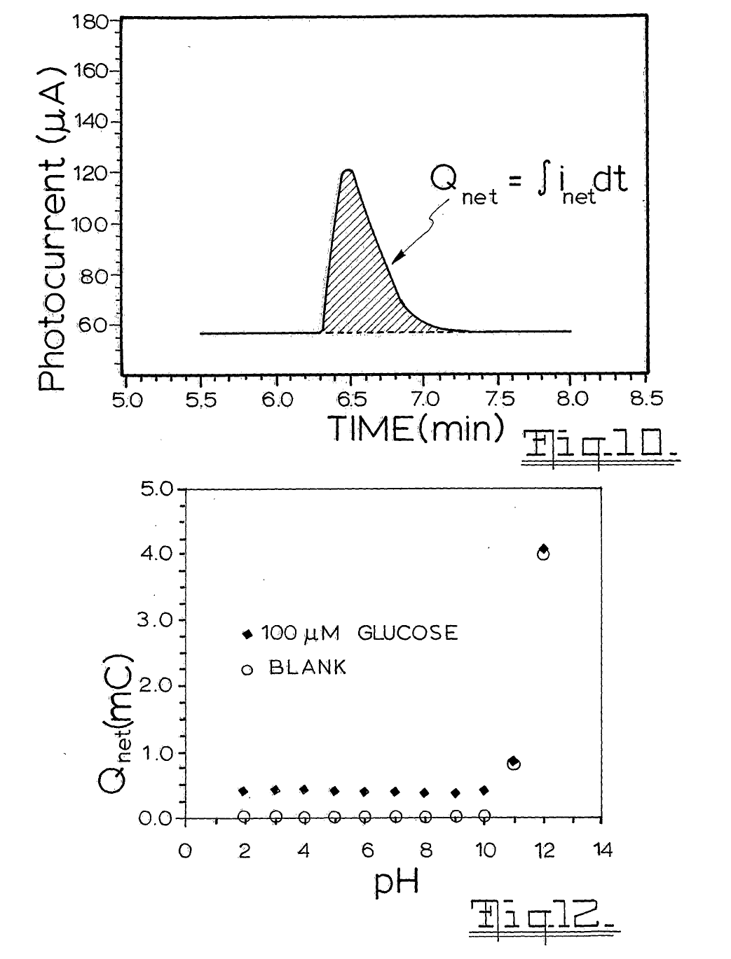

FIG. 8 shows a set of typical photocurrent responses. The calibration curve (the insert within FIG. 8) was then used for real sample COD calculations, in accordance with Equation 9.

COD values so obtained were subsequently plotted against the COD value determined by standard dichromate COD method, as shown in FIG. 9. The Pearson Correlation coefficient between the values obtained from the flow injection photoelectrochemical COD method and the standard COD method indicate a highly significant correlation (r=0.996, P=0.000, n=17) between the two methods. This almost unity slope (1.06) indicates that both methods accurately measure the same COD value. At a 95% confidence interval, the slope is between 0.9973 and 1.155. Considering the analytical errors associated with both the flow injection photoelectrochemical COD and the standard method measurements will contribute to scatter on both axes, the strong correlation and slope obtained offers compelling support for the suitability of the flow injection photoelectrochemical COD method for measuring Chemical oxygen demand.

It is notable that a practical detection limit of 0.5 ppm COD with a linear range up to 60 ppm COD is achievable under the experimental conditions employed. The detection limit can be further extended by increasing the sample injection volume, while the linear range can be increased by using smaller injection volumes. Response reproducibility was also tested. Repetitive injections (n=21) of 100 μM glucose gave an RSD % of 0.8%.

### Method 2

In this second method, the materials and sample preparation, electrode preparation and apparatus are the same as for method 1.

### Detection Principle

Under suitable conditions, the photocurrent originating from the photocatalytic oxidation of organics can be obtained and subsequently used as the analytical signal for determination of COD, as it represents the extent of oxidation. The thin-layer photoelectrochemical detector (see FIG. 1) used in this work is a consumption type detector as the organic compounds in the sample are photoelectrochemically oxidized at the TiO₂ working electrode.

In the applicant's previous patent filing, (WO 2004/088305), exhaustive degradation was achieved by employing a stop-flow operation mode. Under those conditions, the number of electrons captured (Qₑₓₕₐᵤₛₜᵢᵥₑ) is equal to the theoretical charge (Q_{theoretical}) of mineralization of an organic compound in the injected sample and can be expressed by Faraday's Law:

$${Q}_{exhaustive} = {Q}_{theoretical} = FV {\sum }_{i = 1}^{m} {n}_{i} {C}_{i} \qquad ( 10 )$$

where n_{i,}, the oxidation number, refers to the number of electrons transferred for an individual organic compound during the photoelectrocatalytic degradation, Cᵢ is the molar concentration of individual organic compound; F and V represent Faraday constant and sample volume, respectively.

However, in the continuous flow mode of this current invention, and under controlled conditions, only a portion of the organic compounds in any sample will have been degraded. This degraded portion can be represented by a, the oxidation percentage, which is defined as:

$$α = \frac{{Q}_{net}}{{Q}_{theoretical}} \qquad ( 11 )$$

Where Qₙₑₜ is the number of electrons captured during the continuous flow detection, while Q_{theoretical} refers to the theoretical charge required for complete mineralization of the injected sample.

If all organic compounds can be oxidized indiscriminately, it can be assumed that the oxidation percentage is a constant, which is similar to the situation that occurs in a consumption-type detection in continuous flow mode. The amount of electrons captured by the detector can be written as:

$${Q}_{net} = α FV {\sum }_{i = 1}^{m} {n}_{i} {C}_{i} \qquad ( 12 )$$

Since each oxygen molecule equals to 4 transferred electrons:

O₂+4H⁺+4e⁻→2H₂O (13)

and according to COD definition, the Qₙₑₜ can be readily converted into equivalent COD value [ref].

$$COD ( mg \text{/} L of {O}_{2} ) = \frac{{Q}_{net}}{4 α FV} \times 32000 = {kQ}_{net} \qquad ( 14 )$$

Equation 14 can be used to directly quantify the COD value of a sample when Qₙₑₜ is obtained, since k, the slope, can be obtained by the calibration curve method or the standard addition calibration method.

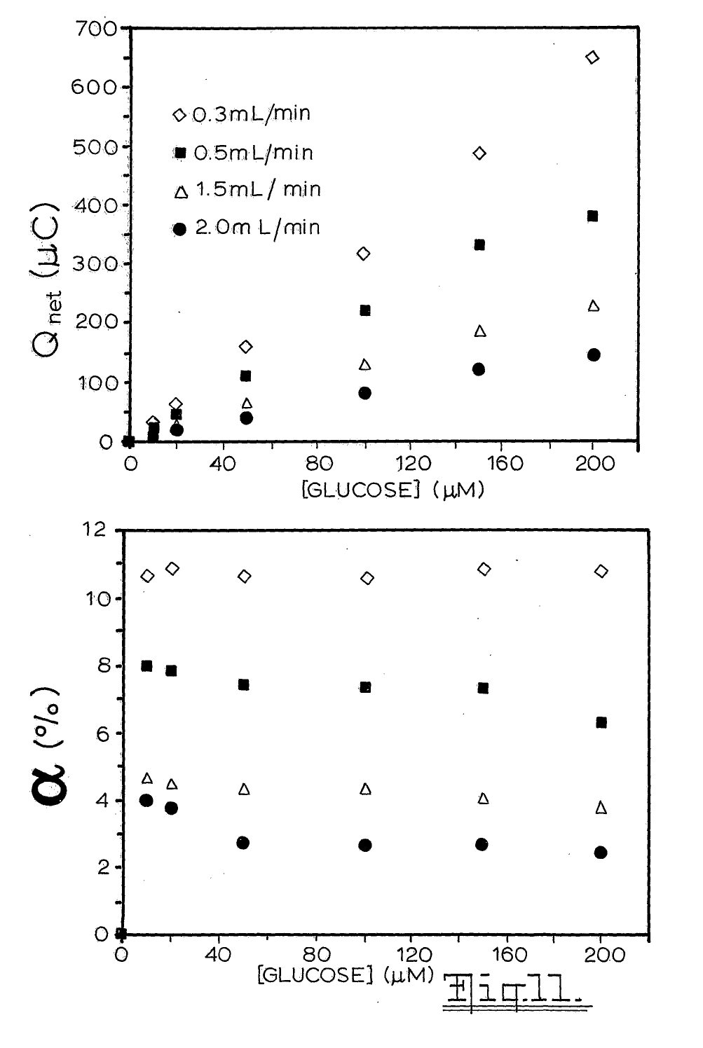

FIG. 10 shows a typical photocurrent-time profile obtained during the degradation of organic compounds under continuous flow conditions. It can be used to illustrate how Qₙₑₜ is obtained. The flat baseline (blank) photocurrent (i_{baseline}) observed from the carrier solution originates from water oxidation, while the peak response observed from the sample injection is the total current of two different components, one that originates from photoelectrocatalytic oxidation of organics (iₙₑₜ), while the other is from water oxidation, (i.e., which is the same as the blank photocurrent). The net charge, Qₙₑₜ, originating from oxidation of organic compounds can be obtained by integration of the peak area between the solid and dashed line, i.e., the shaded area as indicated in FIG. 10.

### Thin-Layer Photoelectrochemical Flow Detector

A thin-layer photoelectrochemical detector was specifically designed to suit on-line photoelectrochemical determination of COD under continuous flow conditions.

The thin-layer configuration is a key feature of the design. Such a configuration is essential to achieve a large (electrode area)/(solution volume) ratio that ensures rapid photodegradation of an injected sample. It also provides reliable and reproducible hydrodynamic conditions, which are crucial for accuracy, reproducibility and reliability. In addition, a thin liquid layer maximises light utilisation efficiency because the aqueous media also absorbs UV radiation. A suitable TiO₂ nanoparticulate electrode was chosen that was mechanically stable, suited to a wide spectrum of organic compounds, and capable of indiscriminate organic compound photooxidation.

The light source is another important component, since the effective light intensity is an important parameter affecting degradation rate. Thus a modified Xenon light source was employed with an output beam regulated in terms of size and intensity of the beam by a group of quartz lenses. A UV-band pass filter was used to reduce infrared radiation reaching the detector, and so prevent solution heating.

### Optimization of Analytical System

A potential bias of +0.3V vs Ag/AgCl was selected to ensure that maximum electron efficiency is achieved.

Effect of flow rate and concentration: Based on the proposed detection principle, the magnitude of analytical signal (Qₙₑₜ) is dependent on the total amount of organics oxidised at the electrode. Therefore for a given injection volume, the total amount of organics oxidised at the electrode is governed by the flow rate (determining the contact time) and concentration (determining mass transport to the electrode).

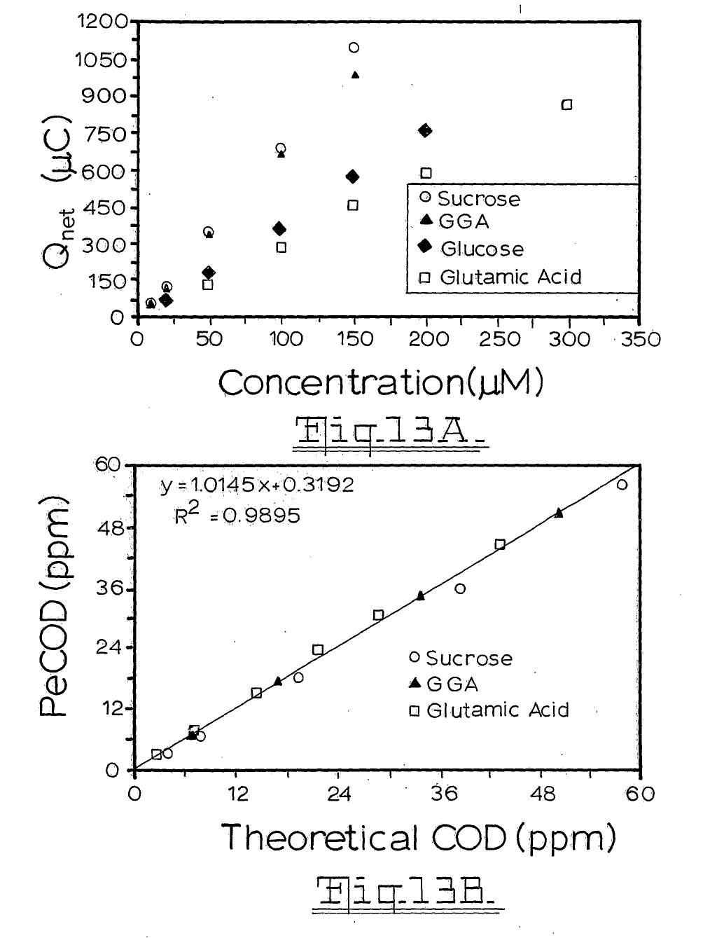

According to Equation 12, Qₙₑₜ should be directly proportional to the molar concentration. Thus FIG. 11 shows the relationship between Qₙₑₜ and concentration obtained from the photodegradation of glucose at various flow rates. A linear relationship within the medium concentration range was observed for all flow rates investigated. This indicates that the oxidation percentage is independent of concentration under these conditions and so rationalises the assumption made for Equation 14. It was noted that the slope of the curve increased as the flow rate decreased. That is, an increase in flow rate results in a decrease in the sensitivity. This is because a low flow rate allows longer sample-electrode contact time for the sample to react, therefore, for a given concentration, more charge resulting from photocatalytic oxidation can be collected. The basis of Equation 14 is further confirmed by the direct relationship between oxidation percentage and concentration (as shown in FIG. 11b). At a low flow rate (0.3 mL/min), the oxidation percentage is constant throughout the concentration range investigated. However, at higher flow rates, a constant oxidation percentage could only be maintained at higher concentrations (>40 μM glucose), and fluctuations in the oxidation percentage are noted at lower concentrations (<40 μM glucose). These results confirm that an increase in flow rate leads to a decrease in the overall oxidation rate and, consequently, in the sensitivity of detection. Considering the overall effect of the flow rate, 0.3 mL/min set as a standard for further work.

### Effect of Injection Volume

The injection volume is one operational parameter that can strongly influence the detection sensitivity and linear range as it determines the sample contact time at the electrode under a constant flow rate.

Table 1 shows the effect of injection volume on the detection limits and linear range. It was found that when injection volume was increased from 13 μL to 262 μL, the detection limit improved from 1 ppm down to 0.1 ppm. However, despite this improvement in detection limit (sensitivity), too high an injection volume can significantly reduce the linear range, as large amounts of analytes can surpass the capacity of the photoelectrochemical detector. When this occurs, the oxidation percentage (α) will change with concentration and Equation 14 will become invalid. Therefore, for the work reported here, a small injection volume of 13 μL was selected to assure the validity of Equation 14. This injection volume was chosen to permit the widest linear range (1-100 ppm COD), at satisfactory sensitivity and detection limits. Additionally, such a small injection volume allows a short assay time.

TABLE 1
Effect of injection volume on detection limit and linear range

| Injection volume | Detection limit | Linear range |
|---|---|---|
| (μL) | (ppm COD) | (ppm COD) |
| 13 | 1 | 1-100 |
| 36 | 0.6 | 1-70 |
| 50 | 0.5 | 1-50 |
| 110 | 0.2 | 0.5-40 |
| 262 | 0.1 | 0.5-20 |

Note:
Flow rate = 0.3 mL/min.

### Effect of pH

FIG. 12 shows the effect of pH on the resultant analytical signal (Qₙₑₜ), where all experiments were carried out under identical conditions except pH change. The conditions for pH<2 were not investigated here because damage of the ITO conductive layer can occur under such acidic conditions. For a given concentration, no significant changes in Qₙₑₜ were observed when the solution pH was varied from 2 to 10. However, a sharp increase in Qₙₑₜ was observed when the solution pH was greater than 10. A question arising from this observation is whether the sharp increase in Qₙₑₜ is due to increasing oxidation efficiency towards the organics or to other factors. Therefore, to clarify this, the effect of solution pH on the blank current (baseline) was investigated. Blank solutions containing 2M NaClO₄ with various pHs were injected. These experiments revealed that within pH range of 2 to 10, a change in solution pH had no measurable effect on the blank current. However, a sharp increase in the blank current was observed when at a solution pH greater than 10. Interestingly, the magnitude of the increase matched the value increase observed from the oxidation of glucose. This implies that the increase in Qₙₑₜ at high pH (in the case of glucose) was due to the increase in the blank current rather than due to any increase in oxidation efficiency towards glucose. Thus, the increase in the blank current (baseline) is due to the increase in water oxidation efficiency at high OH⁻ concentration. This suggests that sample pH should be adjusted to be in the suitable range (2<pH<10) before analysis.

### Synthetic Sample Analysis

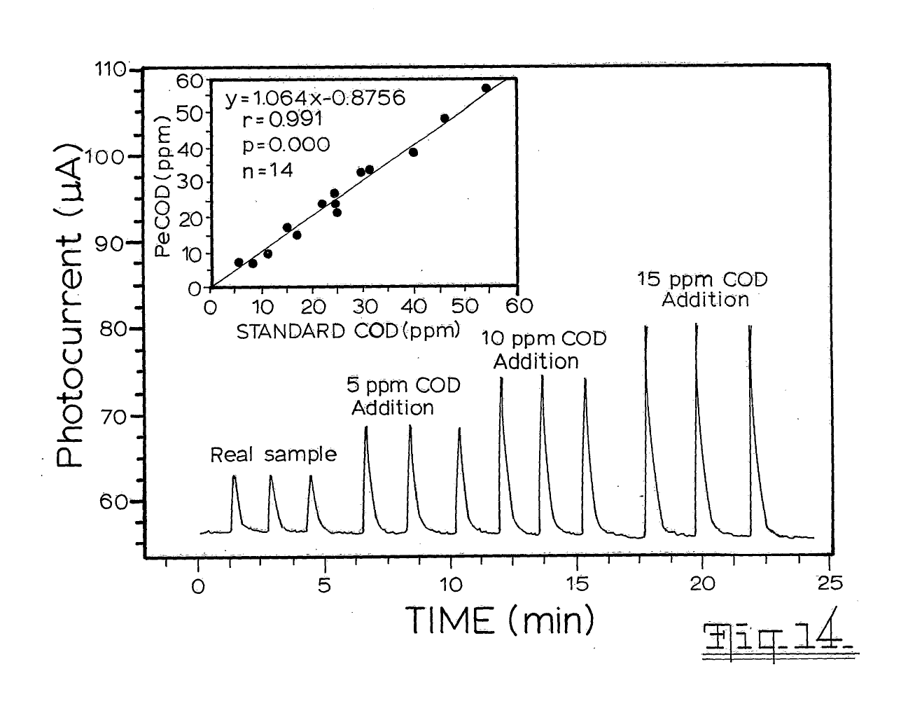

The applicability of the proposed detection principle was examined using synthetic samples prepared with pure organic compounds with known theoretical COD value. FIG. 13 a) shows the plot of Qₙₑₜ against synthetic sample concentration in μM. Different slopes for different synthetic sample were observed. It revealed that the slopes decreased in the order of sucrose>GGA>glucose>glutamic acid. This is because the mineralisation of different organic compounds requires different numbers of electrons. For a given molar concentration, an organic compound having a larger n will generate more charge, hence a larger slope as shown in FIG. 13 a). The numbers of electrons required for mineralisation of one mole of the above samples are: sucrose (n=48 moles)>GGA (n=42 moles)>glucose (n=24 moles)>glutamic acid (n=18 moles), which is in the same order as that of the slopes in the figures.

According to Equation 14, the measured net charge should be directly proportional to the COD value of the sample. The μM concentration shown in FIG. 13 a can be converted into the equivalent COD value according to the oxidation number (n). Plotting Qₙₑₜ against the theoretical COD value of the synthetic samples gives a straight line, y=19.605x+1.5887, R²=0.999. This demonstrates that the conversion of molar concentration of different samples into equivalent COD values is an effective normalisation process. For a given sample with known concentration, the theoretical charge (Q_{theoretical}) required for mineralisation can be readily calculated using Equation 10. Therefore, the oxidation percentage (α) can be calculated once the net charge (Qₙₑₜ) of the sample is obtained using Equation 11. In FIG. 13b, glucose was used as a calibration standard to obtain a slope k. The COD values of the synthetic samples can then be calculated according to Equation 14 using the slope k. FIG. 13 b shows the photoelectrochemical COD (PeCOD) values plotted against theoretical COD values. The trendline of best fit has a slope of 1.0145 with a R² of 0.9895, which demonstrates the applicability of Equation 14. A detection limit of 0.1 ppm COD and a linear range up to 100 ppm COD can be achieved depending on the injection volume and flow rate. The detection limit can be further improved by increasing the sample injection volume while the linear range can be extended by a further decrease of injection volume. The reproducibility is represented by RSD % of 0.8% that obtained from 12 repeated injections of 100 μM glucose. No significant change for Qₙₑₜ was obtained from injections of 100 μM glucose over a period of 60 days. The electrode fouling caused by organic contamination and bacteria growth was not observed during the storage due to the well-known merits of self-cleaning ability of TiO₂ (24).

### Real Sample Analysis

The applicability of the method for real sample analysis was examined. The pH of the real samples tested in this work was within the range of 6-8 (the pH independent region). The standard addition method can be used to determine the COD value in real sample to eliminate possible signal variation caused by the complex sample matrix. FIG. 14 shows the typical photocurrent profile of the continuous flow responses, and the COD value of the real sample determined using standard addition method.

Each sample was analysed by both the continuous flow photoelectrochemical method and the standard dichromate method. The insert in FIG. 14 shows the correlation between the COD values obtained by both methods. The Pearson Correlation coefficient between the values obtained indicate a highly significant correlation (r=0.991, P=0.000, n=14) between the two methods. The almost identical slope (1.064) indicates that both methods accurately measure the same COD value. At a 95% confidence interval, this slope was between 1.001 and 1.154. Considering the analytical errors associated with measurements performed by both methods and that these errors contribute to scatter on both axes, the strong correlation and almost unity in slope obtained demonstrates the applicability of the continuous flow photoelectrochemical method for determination of chemical oxygen demand.

From the above it can be seen that this invention provides an improved method and apparatus for use in continuous COD analysis of water samples. Those skilled in the art will realize that this invention may be implemented in embodiments other than those described without departing from the core teachings of the invention.

1. A method of determining chemical oxygen demand (COD) of a water sample, comprising the steps of
a) applying a constant potential bias to a photoelectrochemical cell, having a photoactive working electrode and a counter electrode, and containing a supporting electrolyte solution;
b) illuminating the working electrode with a light source and recording the background photocurrent produced at the working electrode from the supporting electrolyte solution;
c) adding a water sample, to be analysed, to the photoelectrochemical cell;
d) illuminating the working electrode with a light source and recording the hydro dynamic photocurrent produced under continuous flow of the water to be analysed;
e) determining the chemical oxygen demand of the water sample using the formula
$$[ COD ] = \frac{γδ}{FAD} \times 8000 {i}_{peak} ( mg \text{/} L of {O}_{2} ) or \\ [ COD ] = \frac{δ}{FAD} \times 8000 {i}_{sp} ( mg \text{/} L of {O}_{2} )$$
where γ is the dispersion coefficient, δ is the concentration diffusion layer thickness, D is the diffusion coefficient, A is the electrode area, F is the Faraday constant, iₚₑₐₖ is the unsaturated photocurrent and iₛₚ is the saturated photocurrent.

2. A method as claimed in claim 1 in which the applied potential is from −0.4 to +O.8V preferably about +0.3V.

3. A method as claimed in claim 1 or 2 in which the water samples are in the pH range of 2 to 10.

4. A method as claimed in claim 1 or 2 in which an injection volume of 13 μL and a flow rate of about 0.3 mL/min is used.

5. A method of measuring COD for online monitoring comprising the steps of
a) applying a constant potential bias to a photoelectrochemical cell, having a photoactive working electrode and a counter electrode, and containing a supporting electrolyte solution;
b) illuminating the working electrode with a light source and recording the background photocurrent produced at the working electrode from the supporting electrolyte solution;
c) adding a water sample, to be analysed, to the photoelectrochemical cell;
d) illuminating the working electrode with a light source and recording the hydro dynamic photocurrent produced under continuous flow of the water to be analysed;
e) determining the chemical oxygen demand of the water sample using the formula
$$COD ( mg \text{/} L of {O}_{2} ) = \frac{{Q}_{net}}{4 α FV} \times 32000 = {kQ}_{net} \\ Where {Q}_{net} = α FV {\sum }_{i = 1}^{m} {n}_{i} {C}_{i} \\ α = \frac{{Q}_{net}}{{Q}_{theoretical}} \qquad ( 3.2 )$$
Qₙₑₜ is the amount of electrons captured during the continuous flow detection,
Q_{theoretical} refers to the theoretical charge required for mineralization of the injected sample
n_{i,} is the oxidation number namely the number of electrons transferred for an individual organic compound during the photoelectrocatalytic degradation,
Cᵢ is the molar concentration of individual organic compound,
F is the Faraday constant,
V is the sample volume,
K is the slope, which can be obtained by calibration curve method or standard addition calibration method.

6. An online analyser for analyzing water quality on a continuous basis which includes
a) an electrochemical cell containing a photoactive working electrode and a counter electrode,
b) a supporting electrolyte solution chamber;
c) a light source to illuminate the working electrode
d) continuous flow injection means to provide a sample solution to the cell
e) control means to
i) actuate the light source and record the background photocurrent produced at the working electrode from the supporting electrolyte solution;
ii) control the flow rate of the water sample, to be analysed, to the photoelectrochemical cell;
iii) actuate the light source and record the hydro dynamic photocurrent produced under continuous flow of the water to be analysed;
iv) determine the chemical oxygen demand of the water sample using flip formula
$$[ COD ] = \frac{γδ}{FAD} \times 8000 {i}_{peak} ( mg \text{/} L of {O}_{2} ) or \\ [ COD ] = \frac{δ}{FAD} \times 8000 {i}_{sp} ( mg \text{/} L of {O}_{2} )$$
where γ is the dispersion coefficient, δ is the concentration diffusion layer thickness, D is the diffusion coefficient, A is the electrode area, F is the Faraday constant, iₚₑₐₖ is the unsaturated photocurrent and iₛₚ is the saturated photocurrent.

7. An analyser as claimed in claim 6 in which the applied potential is from −0.4 to +O.8V preferably about +0.3V.

8. An analyser as claimed in claim 6 or 7 in which an injection volume of 13 μL and a flow rate of about 0.3 mL/min is used.

9. An analyser as claimed in claim 6 in which the chemical oxygen demand is determined using the formula
$$COD ( mg \text{/} L of {O}_{2} ) = \frac{{Q}_{net}}{4 α FV} \times 32000 = {kQ}_{net} \\ Where {Q}_{net} = α FV {\sum }_{i = 1}^{m} {n}_{i} {C}_{i} \\ α = \frac{{Q}_{net}}{{Q}_{theoretical}} \qquad ( 3.2 )$$
Qₙₑₜ is the amount of electrons captured during the continuous flow detection,
Q_{theoretical} refers to the theoretical charge required for mineralization of the injected sample
n_{i,} is the oxidation number namely the number of electrons transferred for an individual organic compound during the photoelectrocatalytic degradation,
Cᵢ is the molar concentration of individual organic compound,
F is the Faraday constant,
V is the sample volume,
K is the slope, which can be obtained by calibration curve method or standard addition calibration method
